(19) United States
(12) Patent Application Publication
(10) Pub. No.: US 2012/0213476 A1
(43) Pub. Date: Aug. 23, 2012

(54) CONNECTION DEVICE FOR AN OPTICAL FIBRE

(75) Inventors: Bodo Bimboese, Frankfurt am Main (DE); Joachim Alfred Hahn, Schmitten (DE); Guido Van De Burgt, Bensheim (DE)

(73) Assignee: TYCO ELECTRONICS AMP GmbH, Bensheim (DE)

(21) Appl. No.: 13/390,862

(22) PCT Filed: Aug. 10, 2010
(86) PCT No.: PCT/EP2010/061613

§ 371 Date: May 7, 2012

(30) Foreign Application Priority Data
Aug. 17, 2009 (DE) 102009028595.4

(51) Int. Cl. G02B 6/36

(52) U.S. Cl. 385/53

(57) ABSTRACT

A connection device for an optical fibre comprises a housing and a first optical fibre arranged therein. In this case, the first optical fibre is fixed in the housing by a stopper.

The invention relates to a connection device for an optical fibre according to claim 1.

Data signals can be transmitted electrically via electric lines or optically via optical fibres. Individual optical fibre portions can be connected to one another via plug connectors. Converters which carry out a conversion between optical and electronic data signals are also known in the art. Converters of this type can for example be in the form of connection devices having on one side one or more electrical contacts, on the other side a possible connection for one or more optical fibres. Connection devices of this type are also referred to as pigtails.

The object of the invention is to provide an improved connection device for an optical fibre. This object is achieved by a connection device for an optical fibre having the features of claim 1. Preferred developments are specified in the dependent claims.

A connection device according to the invention for an optical fibre has a housing containing a first optical fibre. In this case, the first optical fibre is fixed in the housing by a stopper.

Advantageously, a connection device of this type may be assembled very easily.

Preferably, the stopper is made of a permanently resilient material. Advantageously, the stopper can then be designed in such a way that it sits securely in the housing and securely fixes the optical fibre.

Preferably, the stopper is made of a material which is stable to heat up to a temperature of at least 200° C. Advantageously, the connection device can then be further processed in a reflow soldering method.

Preferably, the stopper consists of silicone. This has the advantage that silicone has beneficial resilient properties which it maintains even during and after high-temperature treatment.

In a preferred development of the connection device, the housing has a first guide groove in which the first optical fibre is arranged. In this case, the optical fibre is pressed by the stopper into the guide groove. An arrangement of this type has the advantage that the guide groove guarantees simple and reliable positioning and orientation of the optical fibre.

It is expedient if the housing has a recess and the first guide groove is arranged in a wall of the recess and the stopper is arranged in the recess itself. Advantageously, this embodiment allows a compact construction and simple assembly of the connection device.

Preferably, the first guide groove widens toward the recess. Advantageously, this ensures precise centring of the optical fibre.

Likewise preferably, the first guide groove has a contour of a prism. Advantageously, this also ensures desired centring of the optical fibre.

According to a development of the connection device, the housing has a pin oriented perpendicularly to the direction of extension of the first optical fibre and the stopper has a through-opening. In this case, the pin is arranged in the through-opening. Advantageously, this facilitates the positioning of the stopper and prevents the stopper from slipping.

Expediently, one end of the pin has at least one barb which impedes accidental removal of the stopper.

Preferably, the first optical fibre is a glass optical fibre. Advantageously, glass optical fibres are insensitive to heat and can therefore be subjected to a subsequent reflow soldering process.

In a development of the connection device, a second optical fibre is provided in the housing parallel to the first optical fibre and the stopper is arranged between the first and the second optical fibre. Advantageously, this development allows the connection of two optical fibres without the housing of the connection device having to be significantly increased in size.

Expediently, the stopper is substantially cuboid in its embodiment.

Preferably, the stopper has three substantially cuboid portions arranged one after another in the direction of extension of the first optical fibre. In this case, surfaces of the first and the third portion of the stopper that face the first optical fibre have a ribbing oriented perpendicularly to the direction of extension of the first optical fibre. Advantageously, this ribbing supports the resilient properties of the stopper.

Preferably, the connection device has at least one electrical contact element. Advantageously, the connection device can then be used for example for conversion between optical and electronic data signals.

Particularly preferably, the connection device has an optoelectronic converter which is provided to carry out a conversion between optical and electronic data signals.

The invention will be described hereinafter in greater detail with reference to the figures. In this case, the same reference numerals are used throughout for identical or equivalent parts. In the drawings:

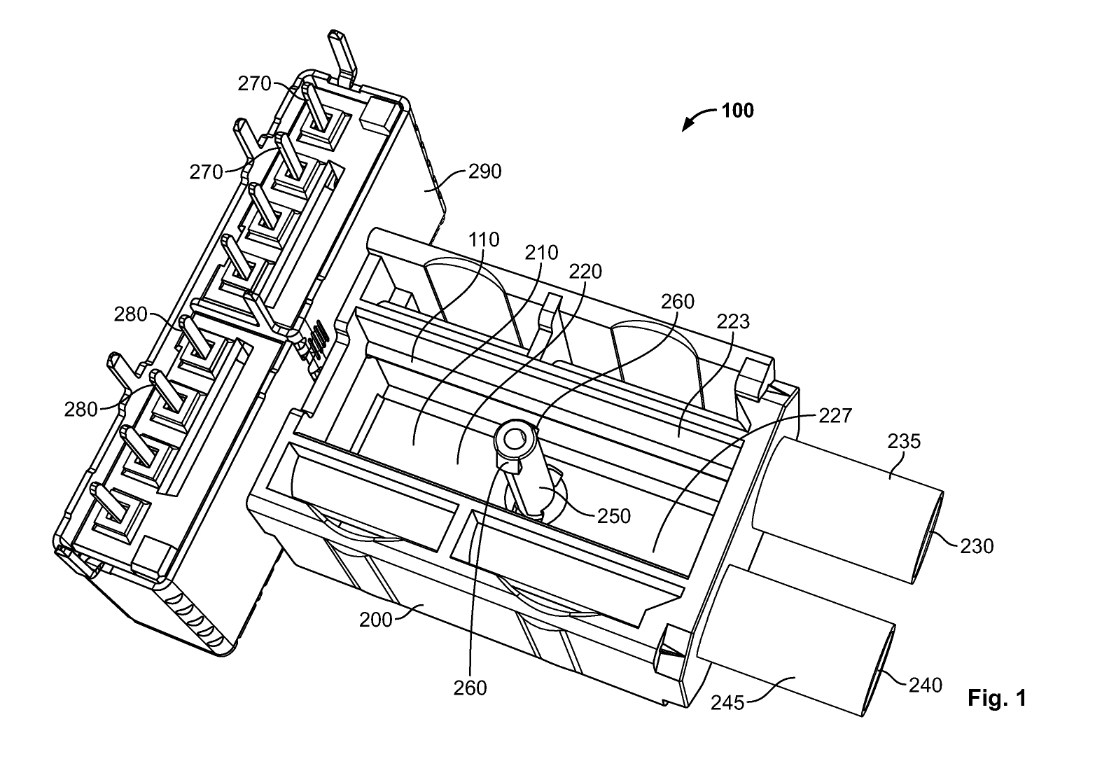

FIG. 1 is a perspective oblique view of a connection device;

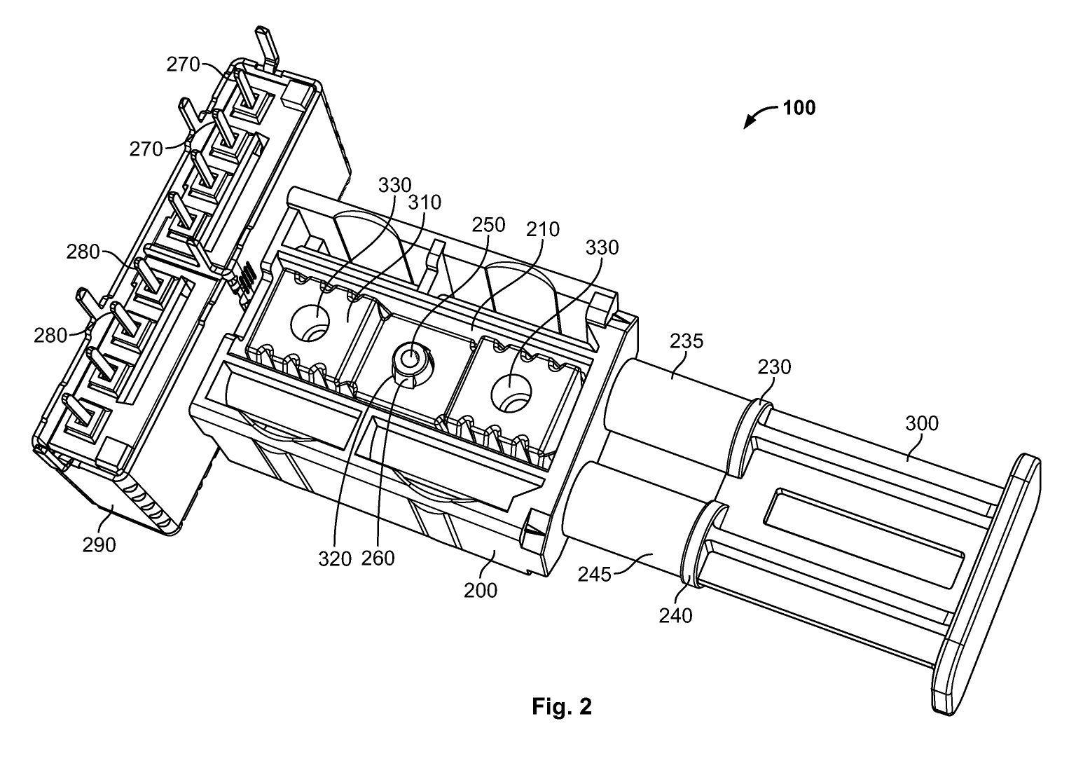

FIG. 2 is a further view of the connection device;

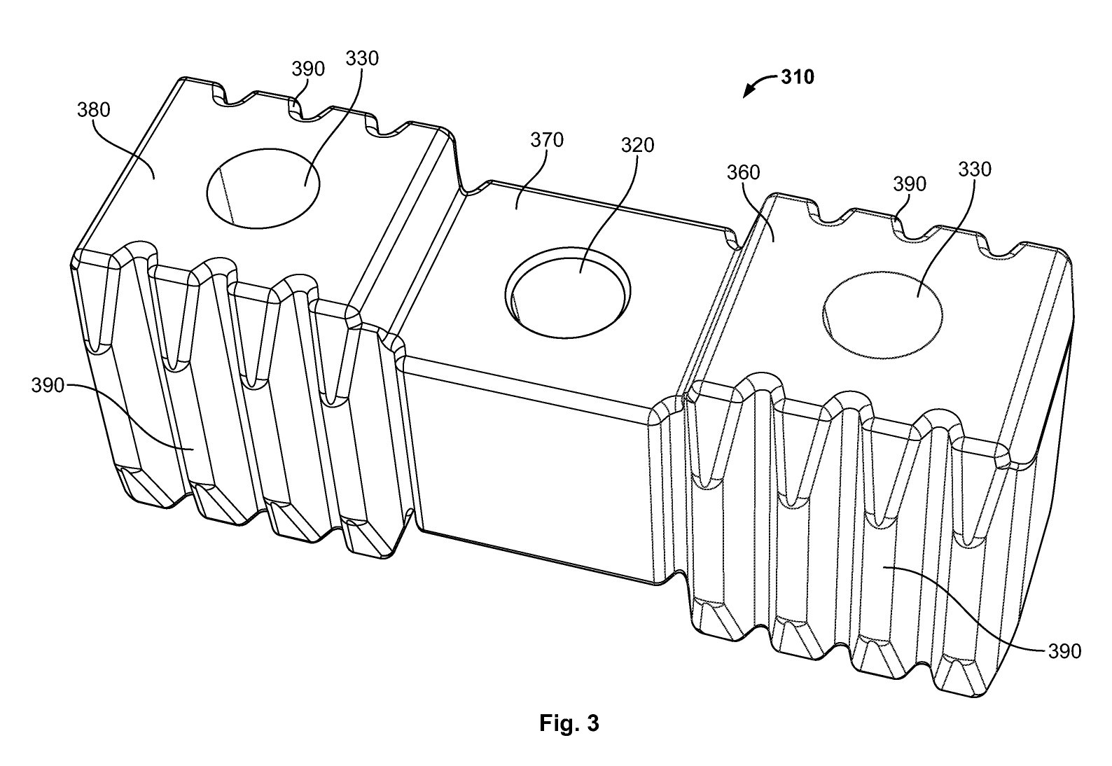

FIG. 3 is a perspective view of a stopper;

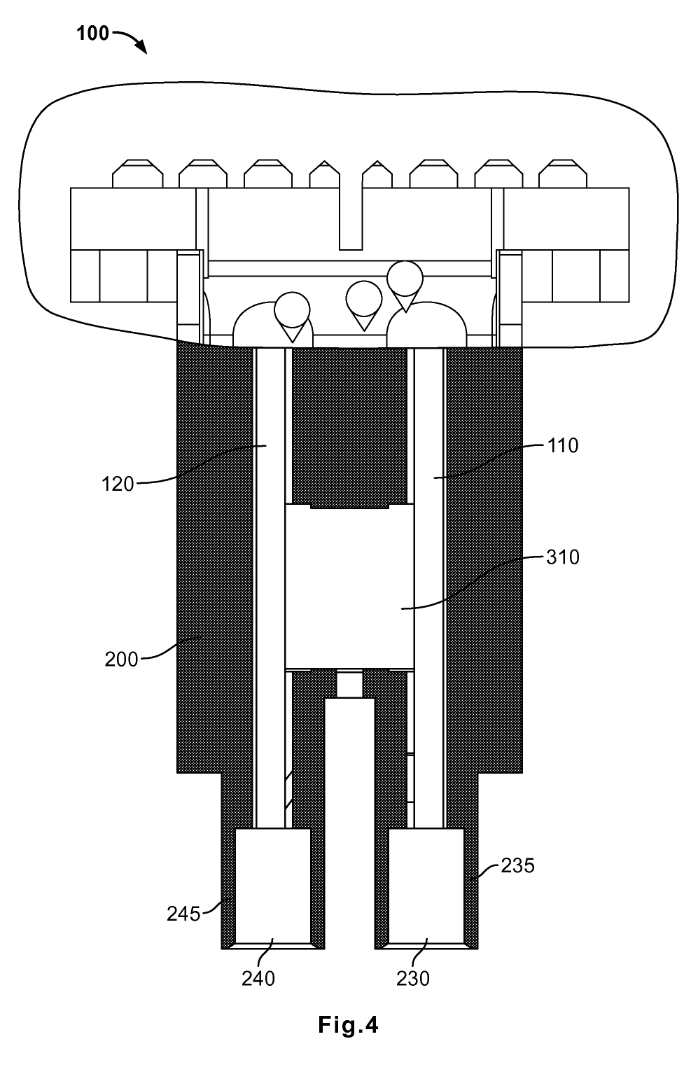

FIG. 4 is a first section through the connection device; and

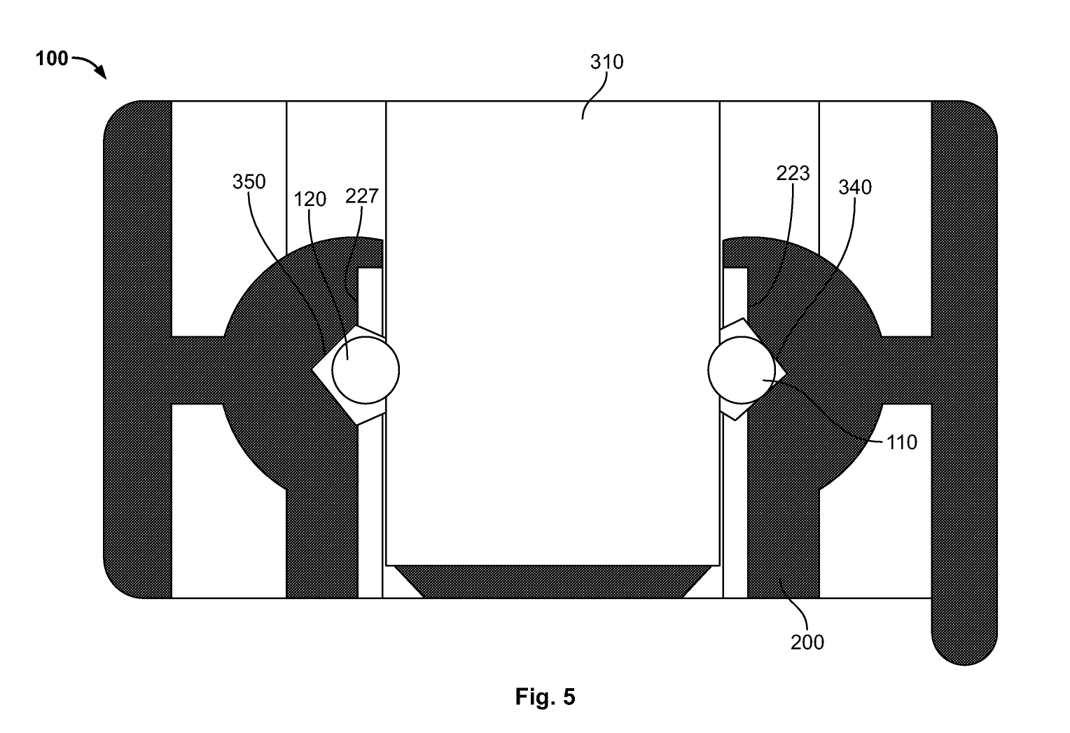

FIG. 5 is a second section through the connection device.

FIG. 1 is a perspective plan view onto a connection device 100 for a first optical fibre 110 and a second optical fibre 120. The connection device 100 may also be referred to as a pigtail.

The connection device 100 comprises a housing 200 which can consist for example of plastics material. The housing 200 has a roughly cuboid basic shape.

A first connection piece 235 with a first access opening 230 and a second connection piece 245 with a second access opening 240 are attached to one end of the cuboid basic shape of the housing 200.

A shielding housing 290, which also has a cuboid basic shape, is attached to the opposite end of the cuboid basic shape of the housing 200. The shielding housing 290 can consist for example of a metal and serves to electromagnetically shield the components arranged in the shielding housing 290. One or more optoelectronic converters, which carry out a conversion between optical and electrical data signals, can for example be arranged in the shielding housing 290.

A plurality of first electrical contact elements 270 and a plurality of second electrical contact elements 280, which provide electrical terminals for the electrical components arranged in the shielding housing 290, for example for optoelectronic converters arranged in the shielding housing 290, protrude from the shielding housing 290. For example, four first electrical contact elements 270 and second electrical contact elements 280 may be present in each case. However, it is also possible to provide just one first electrical contact element 270 and one second electrical contact element 280 or a different number of first electrical contact elements 270 and second electrical contact elements 280. The electrical contact elements 270, 280 can for example be in the form of contact pins. The electrical contact elements 270, 280 can be provided to be connected to a printed circuit board by reflow soldering.

The housing 200 has a recess 210 which can be accessed from a surface of the housing 200. The recess 210 can also have a cuboid form. The recess 210 is delimited by a housing floor 220, by a first housing wall 223 and by a second housing wall 227. The housing floor 220, the first housing wall 223 and the second housing wall 227 each run from the side of the housing 200 that has the connection pieces 235, 245 to the side of the housing 200 that has the shielding housing 290. The first housing wall 223 is positioned opposite the second housing wall 227.

A first guide groove 340, which extends from the side of the housing 200 that has the first connection piece 234 to the side of the housing 200 that has the shielding housing 290, is provided in the first housing wall 223. The first optical fibre 110 is inserted into the first guide groove 340. A first end of the first optical fibre 110 is arranged in the first connection piece 234. From there, the first optical fibre 110 extends through an opening in the housing 200 into the recess 210, where it runs in the first guide groove 340, which is arranged in the first housing wall 223, up to a second opening in the housing 200 and an opening in the shielding housing 290. In the shielding housing 290, the first optical fibre 110 ends on a component arranged in the shielding housing 290, for example an optoelectronic converter.

A second guide groove 350, which extends parallel to the first guide groove 340, is arranged in the second housing wall 227 opposing the first housing wall 223. The second optical fibre 120 is inserted in the second guide groove 350. The second optical fibre 120 extends from the second connection piece 245 through the second guide groove 350 up to a component arranged in the shielding housing 290. The second guide groove 350 and the second optical fibre 120 cannot be seen in FIG. 1.

The first optical fibre 110 can be accessed through the first access opening 230 in the first connection piece 235. The second optical fibre 120 can be accessed through the second access opening 240 in the second connection piece 245.

A roughly cylindrical pin 245 is also arranged in the recess 210. The pin 250 is positioned perpendicularly on the housing floor 220 and is connected to the housing floor 220. As a result, the pin 250 runs parallel to the first housing wall 223 and to the second housing wall 227. The pin 250 is arranged centrally between the first housing wall 223 and the second housing wall 227 and roughly centrally between the side of the housing 200 that has the first connection piece 234 and the side of the housing 200 that has the shielding housing 290.

The end of the pin 250 that is remote from the housing floor 220 has two barbs 260, the steep sides of which face the housing floor 220 and the flat sides of which point away from the housing floor 220. Alternatively, it is also possible to provide just one barb 260 or even no barb 260 at all.

FIG. 2 is a further perspective view of the connection device 100. In the illustration of FIG. 2, a dust protection cap 300, which closes the first access opening 230 and the second access opening 240, is attached to the first connection piece 235 and the second connection piece 245 in order to protect the first optical fibre 110, which is arranged in the first connection piece 235, and the second optical fibre 120, which is arranged in the second connection piece 245, from soiling.

In addition, in the illustration of FIG. 2, a stopper 310 is inserted into the recess 210 in the housing 200. The stopper 310 consists of a permanently resilient and heat-resistant material, for example of silicone.

FIG. 3 is an enlarged illustration of the stopper 310. The stopper 310 has a roughly cuboid basic shape, the dimensions of which correspond to the dimensions of the recess 210. The stopper 310 consists of a first portion 360, a second portion 370 and a third portion 380. The three portions 360, 370, 380 are, for their part, each roughly cuboid in their embodiment and arranged one after another. The two external portions 360, 380 of the stopper 310 each have a cylindrical opening 330. Each of the openings 330 extends from a surface of the stopper 310 to an opposing surface of the stopper 310. The openings 330 can for example serve to reduce the weight of the stopper 310 and to improve the resilient properties of the stopper 310. The openings 330 may also be dispensed with.

The central portion 370 of the stopper 310 has a through-opening 320 which also has a cylindrical contour and extends between two mutually opposing surfaces of the stopper 310. The through-opening 320 is oriented parallel to the openings 330. FIG. 2 shows that the diameter of the through-opening 320 is somewhat larger than or precisely the same size as the diameter of the pin 250 of the housing 200 of the connection device 100. The through-opening 320 of the stopper 310 is placed onto the pin 250 in the recess 210. In other words, the pin 250 extends through the through-opening 320 of the stopper 310. The dimensions of the length of the pin 250 are in this case such that the barbs 260 of the pin 250 are arranged outside the stopper 310 and impede or prevent accidental removal of the stopper 310 from the recess 210 of the housing 200.

The two outer faces, facing the first housing wall 223 and the second housing wall 227, of the first portion 360 of the stopper 310 and the two faces, facing the first housing wall 223 and the second housing wall 227, of the third portion 380 of the stopper 310 each have a ribbing 390. The ribbing 390 consists of troughs and peaks, oriented perpendicularly to the direction of extension of the guide grooves 340, 350, in the respective surfaces of the stopper 310. The ribbing 390 can improve the resilient properties of the stopper 310. The ribbing 390 may also be dispensed with.

The dimensions of the stopper 310 are such that it completely fills the recess 210 of the housing 200. In particular, the stopper 310 completely fills the recess 210 in the direction between the first housing wall 223 and the second housing wall 227. As a result, the stopper 310 presses the first optical fibre 110 into the first guide groove 340 and the second optical fibre 120 into the second guide groove 350. The optical fibres 110, 120 are therefore held by the stopper 310 in the guide grooves 340, 350.

FIG. 4 is a sectional illustration of the connection device 100. The section runs parallel to the direction of extension of the optical fibres 110, 120 and through the optical fibres 110, 120. It may be seen that the positions of the guide grooves 340, 350 or the distance between the first optical fibre 110 and the second optical fibre 120, the distance between the first connection piece 235 and the second connection piece 245 and the width of the stopper 310 are adapted to one another in such a way that the first optical fibre 110 and the second optical fibre 120 run in a straight line between the first connection piece 235 or the second connection piece 245 and the shielding housing 290. The first optical fibre 110 can be accessed in the first connection piece 235 through the first access opening 230. The second optical fibre 120 can be accessed in the second connection piece 245 through the second access opening 240.

FIG. 5 is a further sectional illustration of the connection device 100. In the illustration of FIG. 5, the section runs perpendicularly to the first optical fibre 110 and to the second optical fibre 120. It is clearly apparent from FIG. 5 that the stopper 310 presses the first optical fibre 110 into the first guide groove 340 in the first housing wall 223 and the second optical fibre 120 into the second guide groove 350 in the second housing wall 227.

The depth of the first guide groove 340 is less than the diameter of the first optical fibre 110. As a result, the first optical fibre 110 protrudes from the first guide groove 340 into the recess 210. The depth of the first guide groove 340 may for example be half the diameter of the first optical fibre 110. This ensures that the stopper 310 can effectively press the first optical fibre 110 into the first guide groove 340.

The first guide groove 340 can have a triangular contour, for example, in the direction of extension. As a result, the first guide groove 340 tapers from the recess 210 into the first housing wall 223. In other words, the first guide groove 340 widens toward the recess 210. Such a contour of the first guide groove 340 ensures precise positioning of the first optical fibre 110 in the first guide groove 340. The first guide groove 340 can also have a non-triangular contour. For example, the first guide groove 340 can have any desired prism contour. The second guide groove 350 is preferably formed in a similar manner to the first guide groove 340.

The guide grooves 340, 350 allow simple assembly of the connection device 100, during which the optical fibres 110, 120 need merely be inserted into the guide grooves 340, 350 and are as a result already oriented with high precision in the desired orientation. Subsequently, the optical fibres 110, 120 can be fixed by inserting the stopper 310.

The optical fibres 110, 120 are preferably glass optical fibres. Glass optical fibres of this type have the advantage of being insensitive to a high-temperature treatment. This allows the connection device 100 to be subjected to a high-temperature treatment, for example reflow soldering, with the optical fibres 110, 120 already assembled. Preferably, the other components of the connection device 100 and the stopper 310 are also insensitive to high temperature. A high temperature of this type may for example be 200° C. or more.

Expert variations of the connection device 100 can have just one optical fibre or more than two optical fibres.

1-16. (canceled)

17. A connection device for an optical fibre, with a housing and a first optical fibre arranged therein, wherein the first optical fibre is fixed in the housing by a stopper.

18. A connection device according to claim 17, wherein the stopper is made of a permanently resilient material.

19. A connection device according to claim 17, wherein the stopper is made of a material which is stable to heat up to a temperature of at least 200° C.

20. A connection device according to claim 17, wherein the stopper consists of silicone.

21. A connection device according to claim 17, wherein the housing has a first guide groove, the first optical fibre being arranged in the guide groove and being pressed by the stopper into the guide groove.

22. A connection device according to claim 17, wherein the housing has a recess, the first guide groove being arranged in a wall of the recess and the stopper being arranged in the recess.

23. A connection device according to claim 22, wherein the first guide groove widens toward the recess.

24. A connection device according to claim 21, wherein the first guide groove has a contour of a prism.

25. A connection device according to claim 17, wherein the housing has a pin oriented perpendicularly to the direction of extension of the first optical fibre, the stopper having a through-opening, the pin being arranged in the through-opening.

26. A connection device according to claim 25, wherein one end of the pin has at least one barb, the barb impeding accidental removal of the stopper.

27. A connection device according to claim 17, wherein the first optical fibre is a glass optical fibre.

28. A connection device according to claim 17, wherein a second optical fibre is provided parallel to the first optical fibre in the housing, the stopper being arranged between the first and the second optical fibre.

29. A connection device according to claim 17, wherein the stopper is substantially cuboid in its embodiment.

30. A connection device according to claim 29, wherein the stopper comprises three substantially cuboid portions arranged one after another in the direction of extension of the first optical fibre, surfaces of the first and the third portion of the stopper that face the first optical fibre having a ribbing oriented perpendicularly to the direction of extension of the first optical fibre.

31. A connection device according to claim 17, wherein the connection device has at least one electrical contact element.

32. A connection device according to claim 31, wherein the connection device has an optoelectronic converter which is provided to carry out a conversion between optical and electronic data signals.
